(19) United States
(12) Patent Application Publication
(10) Pub. No.: US 2026/0241670 A1
(43) Pub. Date: Aug. 20, 2026

(54) GLAZED ELEMENT COMPRISING A SYSTEM FOR PREDICTING AND/OR DETECTING CONDENSATION

(71) Applicant: SAINT-GOBAIN GLASS FRANCE, COURBEVOIE (FR)

(72) Inventor: David CHAUVIN, AUBERVILLIERS (FR)

(21) Appl. No.: 18/869,951

(22) PCT Filed: May 31, 2023
(86) PCT No.: PCT/EP2023/064526

§ 371 Date: Nov. 27, 2024

(30) Foreign Application Priority Data
May 31, 2022 (FR) 2205220

(51) Int. Cl. B32B 17/10; G01J 5/12; G01N 25/66; G01N 27/22

(52) U.S. Cl. CPC B32B 17/10211; G01J 5/12; G01N 25/66; G01N 27/223

(57) ABSTRACT

A glazed element for a vehicle, includes a glazed unit extending along a main surface, a first temperature sensor of the ambient environment at a first point outside the glazed unit, a humidity sensor arranged to acquire a relative humidity of the ambient environment and an assembly including at least a second temperature sensor, the assembly being configured to acquire a plurality of second temperatures at third points of the first surface different from one another.

### FIELD OF THE INVENTION

The present invention relates to the detection of condensation on a vehicle glazed unit. In particular, it relates to a glazed element for a vehicle comprising a glazed unit and a system for predicting and/or detecting condensation on the glazed unit.

### STATE OF THE ART

During the appearance of condensation droplets on the internal face of a glazed unit of a vehicle, it is known to manually activate an ambient temperature and/or ventilation regulator in the vehicle, so as to control the evaporation of the condensation droplets.

However, this method can distract the driver of the vehicle. Furthermore, this method is only possible when the condensation droplets have already appeared and have already impaired the visual perception of the driver through the glazed unit.

To this end, document EP 3 552 004 describes a capacitive condensation sensor comprising interdigital electrodes inserted in a glazed unit. During the formation of the condensation on the internal face of the glazed unit, the capacity measured by the sensor varies. Thus, it is possible to dispense with visual detection of the condensation, and to reduce the driver's loss of concentration.

However, the sensor disclosed in document EP 3 552 004 does not make it possible to detect the smallest droplets of condensation. Thus, it is possible that the condensation can be perceptible by the driver before it is detected by the capacitive sensor.

Furthermore, the capacitive detection of the condensation can have a latency of the order of about ten seconds. For example, a known condensation sensor comprises a material capable of absorbing the water of a condensation droplet. In this case, the electrical capacity of this material is measured by the sensor and the latency of the sensor can depend on the water absorption kinetics of the material. This latency may be sufficient for a condensation density to increase and thus impair the visual perception of the driver.

Finally, it is not possible to predict the nucleation of condensation droplets using the sensor described in document EP 3 552 004.

### OVERVIEW OF THE INVENTION

One aim of the invention is to propose a solution for predicting and/or for detecting the appearance of condensation on the internal face of the windscreen of a vehicle before the condensation droplets are perceptible by the driver of the vehicle.

This aim is achieved in the context of the present invention by means of a glazed element for a vehicle, comprising a glazed unit extending along a main surface, the glazed unit comprising a first sheet of glass, the first sheet of glass having a first face, the first face being able to be in contact with an ambient environment inside the vehicle and to support the nucleation of a condensation droplet,
the glazed element being characterized in that it comprises:
   a first temperature sensor configured to acquire a first temperature T₁ of the ambient environment at a first point outside the glazed unit, a first distance d₁ between the first point and a point of the first face closest to the first point being between 20 μm and 5 cm,
   a humidity sensor configured to acquire a relative humidity RH of the ambient environment at a second point outside the glazed unit, a second distance d₂ between the second point and a point of the first face closest to the second point being between 20 μm and 5 cm, the first point preferably coinciding with the second point,
an assembly comprising at least a second temperature sensor, the assembly being configured to acquire a plurality of second temperatures T₂ at third points of the first face different from each other.

The present invention is advantageously completed by the following features, taken individually or in any of their technically possible combinations:
the glazed assembly comprises a control unit configured to:
acquire the first temperature T₁ of the ambient environment by the first temperature sensor,
acquire the humidity level RH of the ambient environment by the humidity sensor,
acquire the plurality of second temperatures T₂ by the assembly, determine a dew point T_{dp} from the first temperature T₁ and from the humidity level RH, and
compare the dew point to a plurality of second temperatures T₂,
the control unit is configured to determine the presence of a condensation droplet on the first face from the comparison of the dew point T_{dp} to the plurality of second temperatures T₂,
the first face comprises a detection surface, the detection surface comprising the third points and running along at least one element chosen from a lateral edge of the glazed unit, a lateral edge on the driver's side of the glazed unit, a lower lateral edge of the glazed unit, a corner of the glazed unit and a lower corner on the driver's side of the glazed unit,
the second temperature sensor is a photodetector configured to detect a light beam having a wavelength comprised in the infrared wavelength range,
the second temperature sensor is an imager, the first face comprising a detection surface, the imager being configured to image the detection surface,
the photodetector comprises an infrared thermopile, the first face comprising a detection surface, the infrared thermopile being mounted on a support configured to orient the infrared thermopile towards each of the third points of the plurality of third points,
the glazed element comprises a housing configured to support a rearview mirror of the vehicle, the photodetector being arranged in the housing,
the assembly comprises a plurality of second temperature sensors, each second temperature sensor being arranged in direct contact with the first face,
at least one of the second temperature sensors comprises a layer formed from an electrically conductive and/or semiconductive material, the layer being in contact with the first face,
the second temperature sensor comprises an electrical circuit configured to measure an electrical resistance of the layer,
the layer is formed by a strip of the material deposited on the first face, preferentially by cathode sputtering,
the layer is transparent,
the electrically conductive and/or semiconductive material is at least chosen from indium-tin oxide and zinc oxide,
the glazed element comprises a voltage generator having two terminals connected to the layer, the generator being configured to generate a voltage greater than 10 V, in particular greater than 20 V and preferentially greater than 40 V.

### DESCRIPTION OF THE FIGURES

Other features, purposes and advantages of the invention will emerge from the following description, which is purely illustrative and non-limiting, and which must be read in conjunction with the appended figures in which:

FIG. 1 schematically shows a glazed element according to one embodiment of the invention,

FIG. 2 schematically shows a cross-section of a glazed element according to one embodiment of the invention,

FIG. 3 schematically shows a detail of a cross-section of a glazed element according to one embodiment of the invention,

FIG. 4 schematically shows a glazed element according to one embodiment of the invention,

FIG. 5 schematically shows a method for predicting and/or detecting condensation according to one embodiment of the invention.

In all the figures, similar elements are marked with identical references.

### Definitions

“Glazed unit” is understood to mean a structure comprising at least one sheet of organic or mineral glass, suitable for being mounted in a vehicle. “Laminated glazed unit” is understood to mean a glazed assembly comprising at least two glass sheets and an interlayer made of plastic material, preferentially viscoelastic, separating the two glass sheets. The interlayer can comprise one or several viscoelastic polymer layers, for example of polyvinyl butyral (PVB) or ethylene-vinyl acetate copolymer (EVA). The interlayer film is preferably standard PVB or acoustic PVB. Acoustic PVB can generally comprise three layers: two outer layers of standard PVB and an inner layer of PVB comprising a plasticizer so as to make the inner layer less rigid than the outer layers.

The glazed unit of the glazed element according to all of the embodiments of the invention has a shape and geometry configured to be mounted on a vehicle according to a predetermined unique position. Thus, it is possible to define, relative to this predetermined position, a lateral edge on the driver's side of the glazed unit, a lateral edge on the passenger's side of the glazed unit, an upper lateral edge of the glazed unit and a lower lateral edge of the glazed unit. In the same way, it is possible to define, relative to this predetermined position, an upper corner on the driver's side of the glazed unit, an upper corner of the passenger's side of the glazed unit, a lower corner on the driver's side of the glazed unit and a lower corner on the passenger's side of the glazed unit.

“Lateral edge on the driver's side” of the glazed unit is understood to mean the lateral edge of the glazed unit on the driver's side when the glazed unit is mounted to the vehicle according to a unique position predetermined by the shape and geometry of the glazed unit.

“Lateral edge on the passenger's side” of a glazed unit is understood to mean the lateral edge of the glazed unit positioned on the passenger's side, opposite the driver's side, when the glazed unit is mounted to the vehicle in a unique position predetermined by the shape and geometry of the glazed unit.

“Upper lateral edge” of a glazed unit is understood to mean the lateral edge of the glazed unit positioned on the upper part of the glazed unit, when the glazed unit is mounted to the vehicle according to a unique position predetermined by the shape and geometry of the glazed unit.

“Lower lateral edge” of a glazed unit is understood to mean the lateral edge of the glazed unit positioned on the lower part of the glazed unit, when the glazed unit is mounted to the vehicle according to a unique position predetermined by the shape and geometry of the glazed unit.

“Upper corner on the driver's side” of a glazed unit is understood to mean the corner of the glazed unit positioned on the upper part of the glazed unit on the driver's side, when the glazed unit is mounted to the vehicle according to a unique position predetermined by the shape and geometry of the glazed unit.

“Lower corner on the driver's side” of a glazed unit is understood to mean the corner of the glazed unit positioned on the lower part of the glazed unit on the driver's side, when the glazed unit is mounted to the vehicle according to a unique position predetermined by the shape and geometry of the glazed unit.

“Infrared wavelength range” is understood to mean the wavelength range between 780 nm and 1 mm, in particular between 780 nm and 20 μm, and preferentially between 780 nm and 2 μm.

“Relative humidity”, or RH for short, is understood to mean the ratio between the partial pressure of the water vapor contained in the ambient air at a temperature and between the saturated vapor pressure at the same temperature.

### DETAILED DESCRIPTION OF THE INVENTION

### General Architecture of the Glazed Element 1 and Theoretical Basis of the Operation of the Glazed Element 1

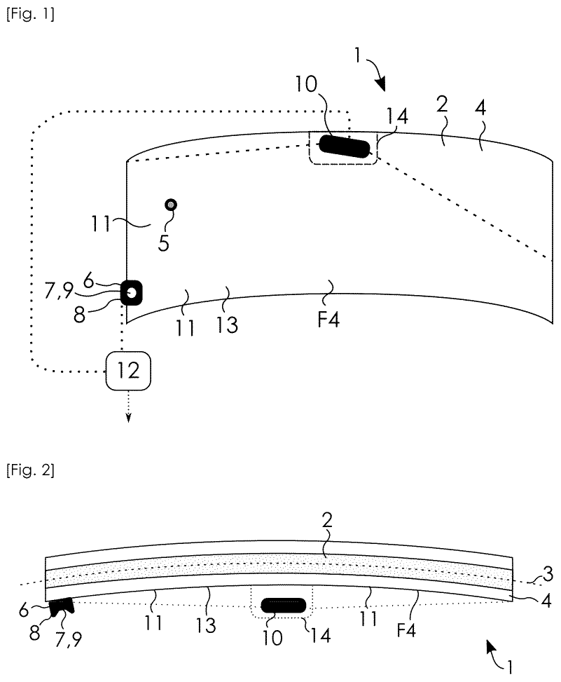

Referring to FIG. 1, a glazed element 1 for a vehicle comprises a glazed unit 2. The glazed unit 2 extends along a main surface 3. The glazed unit 2 comprises a first glass sheet 4. The first glass sheet 4 has a second face F4 capable of being in contact with a surrounding environment inside the vehicle and of supporting the nucleation of a condensation droplet 5. The glazed unit 1 may be a laminated glazed unit.

The glazed element 1 comprises a first temperature sensor 6 configured to acquire a first temperature T₁ of the ambient environment at a first point 7 outside the glazed unit 2. The first temperature sensor 6 may comprise a probe arranged at the first point 7. A first distance d₁ between the first point 7 and a point of the first face F4 closest to the first point 7 is between 20 μm and 5 cm, preferably between 5 μm and 2 cm, preferably between 1 mm and 1 cm.

The glazed element 1 comprises a humidity sensor 8 configured to acquire a relative humidity RH of the ambient environment at a second point 9 outside the glazed unit 2. The humidity sensor 8 may comprise a probe arranged at the second point 9. A second distance d₂ between the second point 9 and a point of the first face F4 closest to the second point 9 is between 20 μm and 5 cm, preferably between 5 μm and 2 cm, preferably between 1 mm and 1 cm.

The glazed element 1 comprises an assembly comprising at least one second temperature sensor 10. The assembly is configured to acquire a plurality of second temperatures T₂ at third points 11 of the first face F4, the third points 11 being different from one another.

Thus, it is possible to compare a dew point T_{dp} in the direct vicinity of the first face F4 at the temperature of the first face F4 at different points of the first face F4. Dew point T_{dp} in the direct vicinity of the first face F4 is understood to mean a dew point at a point located at a distance of between 20 μm and 5 cm, preferably between 500 μm and 2 cm, preferably between 1 mm and 1 cm from the first face F4. Indeed, the inventors have discovered that it was possible to accurately predict or detect the nucleation of condensation droplets 5 on the first face F4 by comparing temperatures at different third points of the first face 4, subject to high temperature variability, to the dew point T_{dp} in the vicinity of the surface.

Indeed, the condensation appears on the first face F4 when the temperature of the first face F4 is less than the dew point T_{dp} (also known as “dew point temperature”) in the vicinity of the first face F4. The dew point T_{dp} in the vicinity of the first face F4 may be calculated from the relative humidity RH of the ambient environment and the first temperature T₁ of the ambient environment in the vicinity of the first face F4. The dew temperature T_{dp} is defined by the equation 1 in the following manner:

$${T}_{dp} = \frac{c \cdot ln \frac{{P}_{vap} ( {T}_{1} )}{a}}{b - ln \frac{{P}_{vap} ( {T}_{1} )}{a}} \qquad ( 1 )$$

wherein Pᵥₐₚ(T₁) is the vapor pressure of the water for the first temperature T₁, a is a constant pressure equal to 6.1121 mbar, b is a constant value equal to 18.678 and c is a constant temperature equal to 257.14° C. Thus, the dew point T_{dp} can be determined from Pᵥₐₚ(T₁).

The steam pressure of the water Pᵥₐₚ(T₁) for the first temperature T₁ is defined by equation 2 and by equation 3 in the following manner:

$$\frac{RH}{100} = \frac{{p}_{vap}}{{p}_{sat}} \qquad ( 2 )$$

$$ln ( \frac{{p}_{sat}}{6.11} ) = ( \frac{Δ {H}_{v}}{{R}_{air}} ) ( \frac{1}{273} - \frac{1}{{T}_{1}} ) \qquad ( 3 )$$

wherein Pₛₐₜ is the saturated vapor pressure of water at temperature T₁, ΔHᵥ is the latent heat of vaporization of the water, equal to 2,461.106 J·kg⁻¹ and Rₐᵢᵣ is the gaseous constant for humid air, equal to 461.0 J·K⁻¹·kg⁻¹.

Thus, a nucleation of a condensation droplet 5 is detected if at least one of the second temperatures T₂ is less than the dew point T_{dp} in the vicinity of the first face F4. In addition, the nucleation of a condensation droplet 5 can be predicted when the difference between at least one of the second temperatures T₂ and between the dew point T_{dp} in the vicinity of the first face F4 is positive and decreases over time.

The glazed element 1 may comprise a control unit 12 configured to:
acquire the first temperature T₁ of the ambient environment by the first temperature sensor 6,
acquire the humidity level RH of the ambient environment by the humidity sensor 8,
acquire the plurality of second temperatures T₂ by the assembly,
determine the dew point T_{dp} from the first temperature T₁ and from the humidity level RH, and
compare the dew point T_{dp} to a plurality of second temperatures T₂.

The control unit 12 may be configured to determine the presence of a condensation droplet on the first face F4 from the comparison of the dew point T_{dp} to the plurality of second temperatures T₂. Preferably, the control unit 12 can be configured to determine a value representative of the presence of a condensation droplet by comparing the dew point T_{dp} to the plurality of second temperatures T₂ and configured to determine the presence of a condensation droplet on the first face F4 from the value representative of the presence of a condensation droplet.

The control unit 12 can be configured to predict the nucleation of a condensation droplet from a series of values representative of the presence of a condensation droplet.

Referring to FIG. 4, another aspect of the invention is a method 400 for determining and/or predicting the presence of a condensation droplet on the first face F4 of the glazed element 1, the method 400 comprising the steps of:
acquiring 401 the first temperature T₁ of the ambient environment by the first temperature sensor 6,
acquiring 402 the humidity level RH of the ambient environment by the humidity sensor 8,
acquiring 403 the plurality of second temperatures T₂ by the assembly,
determining 404 the dew point T_{dp} from the first temperature T₁ and from the humidity level RH, and
comparing 405 the dew point temperature T_{dp} to least one of the second temperatures T₂ and preferably to a plurality of second temperatures T₂.

The method may comprise a step 406 of determining the presence of a condensation droplet 5 from the comparison 405. Preferably, the step of determining 406 may comprise a sub-step of determining a value representative of the presence of a condensation droplet by comparing the dew point T_{dp} to the plurality of second temperatures T₂, then a sub-step of determining the presence of a condensation droplet on the first face F4 from the value representative of the presence of a condensation droplet.

The method may comprise a step of repeating the steps of acquiring 401, of acquiring 402, of acquiring 403, of determining 404, of comparing 405, and of determining 406, then a step of comparing 407 the representative values determined by each of the steps of determining 406. Thus, it is possible to predict the nucleation or the presence of condensation droplets 5 on the first face F4.

The method may comprise, following the step of determining 406 and/or in the step of comparing 407, a step of updating a heating, ventilation and air conditioning (HVAC) system of the vehicle, so as to increase the ambient temperature of the vehicle and/or the temperature of the first face F4, following the determination of the presence of condensation droplets 5 and/or the prediction of the nucleation of condensation droplets 5. Thus, it is possible to carry out the evaporation of the condensation droplets 5 and/or to avoid the nucleation of the condensation droplets 5.

### First Temperature Sensor 6

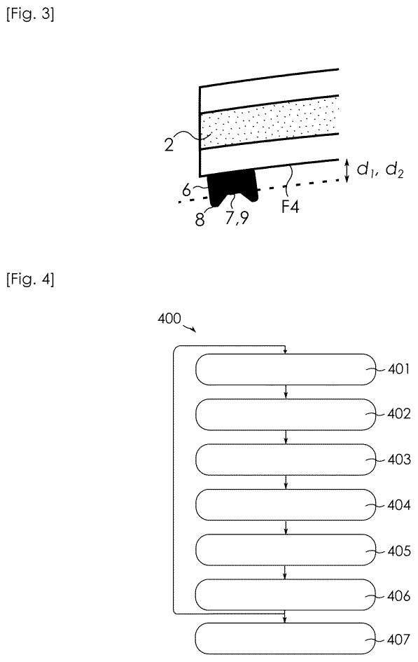

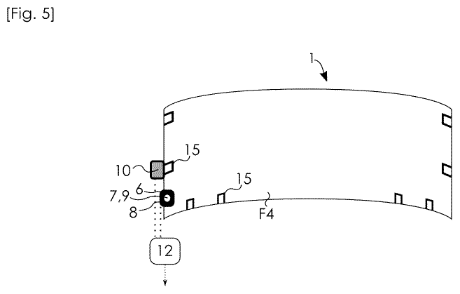

With reference to FIG. 3, the first temperature sensor 6 may be a band-gap temperature sensor. Such a sensor comprises a semiconductor material and is configured to determine an ambient temperature from the characterization of a band-gap of the semiconductor material. The first band-gap temperature sensor 6 may be a sensor of the SHT21 type marketed by Sensirion (registered trademark).

The first temperature sensor 6 may comprise a support, separating the first point 7 from the first face F4 by the first distance d₁. The support may be fixedly mounted to the first face F4.

### Humidity Sensor 8

With reference to FIG. 3, the humidity sensor 8 may be a sensor of the capacitive type configured to acquire a relative humidity RH of the ambient environment. The humidity sensor 8 can be a sensor of the SHT21 type marketed by the company Sensirion (registered trademark).

The humidity sensor 8 and the first temperature sensor 6 can be integrated. The first point 7 may coincide with the second point 9. “Coincide” is understood to mean that the distance between the first point 7 and the second point 9 is less than 5 mm, preferably less than 2 mm, preferably less than 1 mm. Thus, the dew point T_{dp} can be measured at a single point in the vicinity of the first face F4.

### Detection Surface 11

The first face F4 comprises a detection surface 13. The detection surface 13 comprises the third points. The detection surface 13 runs along at least one element selected from a lateral edge of the glazed unit 2, a lateral edge on the driver's side of the glazed unit 2, a lower lateral edge of the glazed unit 2, a corner of the glazed unit 2 and a lower corner on the driver's side of the glazed unit 2.

Indeed, the inventors have discovered that the parts of the first face F4 described above are able to withstand the nucleation of condensation droplets 5 before the nucleation of the condensation droplets 5 on the other parts of the first face F4. Thus, it is possible to detect the nucleation of the condensation droplets 5 before they are visually detectable by the driver of the vehicle on the rest of the first surface F4.

### Second Temperature Sensor 10

The second temperature sensor 10 may be a photodetector configured to detect a light beam having a wavelength comprised in the infrared wavelength range. Thus, it is possible to measure a second temperature T₂ from the first face F4 at a distance, using a single sensor and by simplifying the measurement of the second temperatures.

The glazed element 1 may comprise a housing 14 configured to support a rearview mirror of the vehicle. The housing 14 can be mounted on the first face F4. The photodetector may be arranged in the housing 14. Thus, it is possible to detect a light beam passing through all the points of the detection surface 13 without visually impeding the driver during the use of the vehicle.

The second temperature sensor 10 may be an imager. The imager is configured to image the detection surface 13. Thus, it is possible to simultaneously acquire the second temperatures T₂ of a plurality of third points 11. The imager may be a camera of the RS-PRO T-10 model of the registered trademark “RS Components”. The imager can be configured to acquire more than ten second temperatures T₂ and preferably more than one hundred second temperatures T₂. Thus, it is possible to increase the accuracy of the detection of the nucleation of a condensation droplet on the first face F4 with regard to detection implemented with a lower number of second temperatures T₂.

The photodetector may comprise an infrared thermopile. The infrared thermopile can be mounted on a support configured to orient the infrared thermopile in the direction of each of the third points 11 of the plurality of third points 11. Thus, it is possible to remotely measure the plurality of second temperatures T₂ while simplifying the manufacture of the glazed element 1, for example facing a glazed element 1 comprising an imager.

The assembly may comprise a plurality of second temperature sensors 10, each second temperature sensor 10 being arranged in direct contact with the first face F4. Thus, it is possible to measure a plurality of second temperatures T₂ of the first face F4.

At least one of the second temperature sensors 10 may comprise a layer 15 formed from an electrically conductive or semiconductor material, the layer 15 being in contact with the first face F4. Thus, it is possible to measure at least one of the second temperatures T₂ by measuring the electrical resistance of the layer 15, which makes it possible to simplify the manufacture of the second temperature sensor 10. The layer(s) 15 can be arranged on a lateral edge of the glazed unit 2, preferentially on a lateral edge on the driver's side of the glazed unit 2, and/or on a lower lateral edge of the glazed unit 2, and/or on a corner of the glazed unit 2, preferentially on a lower corner on the driver's side of the glazed unit 2. Thus, it is possible to measure a second temperature T₂ at a location of the first face F4 where the nucleation of the condensation droplets 5 preferentially takes place during the operation of the vehicle, which makes it possible to determine the presence of condensation more quickly and/or to predict the nucleation of a condensation droplet more accurately.

The second temperature sensor 10 may comprise an electrical circuit configured to measure an electrical resistance of the layer 15. Thus, it is possible to measure the temperature of the first face F4 at the third point 11 where the layer 15 is arranged. Indeed, the measured electrical resistance is dependent on the temperature of the layer 15, which is substantially equal to the temperature of the first face F4. The layer 15 may have two ends according to a projection onto the main surface 3. The electrical resistance can be measured between the two ends. The glazed element 1 may comprise a voltage generator having terminals electrically connected to the layer 15. The voltage generator can be configured to generate a voltage less than 10 V, in particular less than 6 V, and preferentially between 1 V and 5 V, so as to measure the electrical resistance of the layer 15 by limiting the temperature variation of the layer 15 driven by the electrical resistance measurement. Preferably, the electrical circuit is configured to measure the electrical resistance of the layer 15 for less than one second, in particular for less than 200 μs, and preferentially for less than 20 μs. The electrical circuit may be configured, equivalently, to measure an electrical resistivity of the layer 15, a conductance of the layer 15 and/or a conductivity of the layer 15.

The layer 15 may be formed by a strip formed by the electrically conductive or semiconductor material, the strip being deposited on the first face F4. The strip may be deposited by sputtering on the first face F4. The layer 15 may be transparent. The material may be chosen from indium-tin oxide and zinc oxide. Thus, the layer 15 may be transparent in the visible wavelengths and not hinder the visibility of the driver through the glazed unit 2. The layer 15 may be doped with metal ions so as to increase the sensitivity of the electrical resistance of the layer 15 to temperature.

The glazed element 1 can be configured to control an increase in the temperature of the glazed unit 2. The glazed element 1 may comprise a voltage generator having two terminals electrically connected to the layer 15. The voltage generator is configured to generate a voltage greater than 10 V, in particular greater than 20 V and preferentially greater than 40 V. Thus, it is possible to increase by Joule effect the temperature of the layer 15 and the temperature of the glazed unit 2 in the vicinity of the layer 15. This makes it possible to prevent the nucleation of condensation droplets 5 and/or to defog the glazed unit 2.

The control unit 12 can be configured to acquire a second temperature T₂ by the second temperature sensor 10. The control unit 12 can be configured to control an increase in the temperature of the glazed unit 2 after having determined the presence of a condensation droplet 5 and/or after having predicted a nucleation of a drop of condensation 5 on the first face F4.

1. A glazed element for a vehicle, comprising a glazed unit extending along a main surface, the glazed unit comprising a first sheet of glass, the first sheet of glass having a first face, the first face being able to be in contact with an ambient environment inside the vehicle and to support nucleation of a condensation droplet, the glazed element comprising:
a first temperature sensor configured to acquire a first temperature of the ambient environment at a first point outside the glazed unit, a first distance d-between the first point and a point of the first face closest to the first point being between 20 μm and 5 cm,
a humidity sensor configured to acquire a relative humidity RH of the ambient environment at a second point outside the glazed unit, a second distance de-between the second point and a point of the first face closest to the second point being between 20 μm and 5 cm,
an assembly comprising at least one second temperature sensor, the assembly being configured to acquire a plurality of second temperatures at third points of the first face different from each other.

2. The glazed element according to claim 1, comprising a control unit configured to:
acquire the first temperature of the ambient environment by the first temperature sensor,
acquire the humidity level RH of the ambient environment by the humidity sensor,
acquire the plurality of second temperatures by the assembly,
determine a dew point from the first temperature and from the humidity level RH,
compare the dew point to a plurality of second temperatures.

3. The glazed element according to claim 2, wherein the control unit is configured to determine a presence of a condensation droplet on the first face from a comparison of the dew point to the plurality of second temperatures.

4. The glazed element according to claim 1, wherein the first face comprises a detection surface, the detection surface-comprising the third points and running along at least one element selected from a lateral edge of the glazed unit, a lateral edge on the driver's side of the glazed unit, a lower lateral edge of the glazed unit, a corner of the glazed unit and a lower corner on the driver's side of the glazed unit.

5. The glazed element according to claim 1, wherein the second temperature sensor is a photodetector configured to detect a light beam having a wavelength in the infrared wavelength range.

6. The glazed element according to claim 5, wherein the second temperature sensor is an imager, the first face comprising a detection surface, the imager being configured to image the detection surface.

7. The glazed element according to claim 5, wherein the photodetector comprises an infrared thermopile, the first face comprising a detection surface, the infrared thermopile being mounted on a support configured to orient the infrared thermopile towards each of the third points of the plurality of third points.

8. The glazed element according to claim 5, comprising a housing configured to support a rearview mirror of the vehicle, the photodetector being arranged in the housing.

9. The glazed element according to claim 1, wherein the assembly comprises a plurality of second temperature sensors, each second temperature sensor being arranged in direct contact with the first face.

10. The glazed element according to claim 9, wherein at least one of the second temperature sensors comprises a layer formed in an electrically conductive and/or semiconductor material, the layer being in contact with the first face.

11. The glazed element according to claim 9, wherein the second temperature sensor comprises an electrical circuit configured to measure an electrical resistance of the layer.

12. The glazed element according to claim 9, wherein the layer is formed by a strip of the material deposited on the first face.

13. The glazed element according to claim 9, wherein the transparent layer.

14. The glazed element according to claim 9, wherein the electrically conductive and/or semiconductive material is at least chosen from indium-tin oxide and zinc oxide.

15. The glazed element according to claim 9 comprising a voltage generator having two terminals connected to the layer, the voltage generator being configured to generate a voltage greater than 10 V.

16. The glazed element according to claim 12, wherein the material is deposited on the first face by cathode sputtering.

17. The glazed element according to claim 15, wherein the voltage is greater than 20 V.

18. The glazed element according to claim 17, wherein the voltage is greater than 40 V.
